(19) United States
(12) Patent Application Publication
(10) Pub. No.: US 2018/0170666 A1
(43) Pub. Date: Jun. 21, 2018

(54) WASTE BIN WITH AN INJECTION MOLDED PLASTIC BODY

(71) Applicant: FRITZ SCHÄFER GMBH, Neunkirchen (DE)

(72) Inventor: Diethelm HIRZ, Neunkirchen (DE)

(21) Appl. No.: 15/127,253

(22) PCT Filed: Apr. 14, 2015
(86) PCT No.: PCT/EP2015/057999

§ 371 Date: Sep. 19, 2016

(30) Foreign Application Priority Data
Apr. 16, 2014 (DE) 10 2014 207 358.8

(51) Int. Cl. B65F 1/02; B65F 1/14; B65F 1/16

(52) U.S. Cl. CPC B65F 1/02; B65F 1/1473; B65D 2501/24808; B65F 2220/12; B65F 2250/114; B65F 1/16

(57) ABSTRACT

The invention relates to a the trash can (1) having an injection-molded plastic body (2) formed by (3, 4, 5, 6) and a bottom wall (8), that are positioned relative to one another so as to together delimit a cavity (15) having an opening (17) opposite the bottom wall (8), wherein each two mutually facing side walls (3, 4, 5, 6) merge into each other in an integral manner in a common corner (11, 12, 13, 14), and wherein an overhang edge (21) which runs around the opening (17) and has a collar (23) that projects radially outward from the side walls (3, 4, 5, 6) is provided on an upper side (16) of the trash can (1), wherein the collar (23) is also supported on the side walls (3, 4, 5, 6) by ribs (28, 51, 52, 53, 54, 55, 56, 57, 58, 59) spaced along the overhang edge (21), and wherein the injection-molded plastic body (2) is partially reinforced with at least one laminar surface reinforcement (35) such that the wall thicknesses of the trash can (1) are reduced as a whole while maintaining the same capacity.

The invention relates to a trash can having an injection-molded plastic body formed by side walls and a bottom wall positioned relative to each other such that the side walls and the bottom wall together define a cavity open away from the bottom wall, each side wall integrally merging with the adjacent side walls at common corners and an overhang edge runs around the opening and has a collar that projects radially outward from the side walls is provided on an upper side of the trash can, the collar being also supported on the side walls by ribs spaced along the overhang edge.

The trash cans in question are already known in the art. Such trash cans may be provided by municipalities for home use, with different filling capacities of 60 l, 120 l, 240 l, 360 l, or the like, for example for holding household trash, biological waste or similar, and for disposal in return for payment.

DE 20 2013 000 851, for example, discloses a trash can made by injection molding in one piece of plastic. This trash can is essentially comprised of a bottom as well as four walls projecting upward therefrom. On the upper side, the trash can is provided with an overhang edge that surrounds an opening of the trash can. This overhang edge reinforces the trash can on the opening's edge, so that the trash can has a locally stable construction, though lacking an end wall. The overhang edge has an outward curved collar constructed in such a way as to allow the overhang edge to be grasped from the outer side and from underneath either manually or mechanically by a lifting and/or gripping device. To further stabilize the overhang edge, and in particular the repeatedly curved collar, reinforcement ribs are also provided underneath the overhang edge and are joined unitarily to the collar and the sides of the trash can. These reinforcement ribs are aligned with the longitudinal extension of four walls projecting from the bottom.

The object of the invention is to improve on a trash can of this type and to facilitate its daily use.

This object of the invention is attained by a trash can having an injection-molded plastic body formed by side walls and a bottom wall positioned relative to each other such that the side walls and the bottom wall together define a cavity open away from the bottom wall, each side wall integrally merging with the adjacent side walls at common corners and an overhang edge runs around the opening and has a collar that projects radially outward from the side walls on an upper side of the trash can, the collar also being supported on the side walls by ribs spaced along the overhang edge, and the injection-molded plastic body being partially reinforced with at least one laminar surface reinforcement such that the wall thicknesses of the trash can are reduced as a whole while maintaining the same capacity.

According to the invention, the plastic body is not simply reinforced on the all sides, in order to be more resistant for daily use. It has been, in fact, also discovered that the entire enclosure of the trash can does not have to be reinforced all sides in order to be provided with an excellent protection against mechanical actions. On the contrary, it is sufficient to reinforce the trash can only partially on those spots or surface areas that, during ordinary daily use, are subject to higher or high loads.

The achieved reduction of wall thickness is in particular relevant to the side walls.

In this way, despite a significantly stiffer trash can, it is possible to reduce weight but also material, and, in particular because of this, production costs of present trash can may be substantially reduced. These manufacturing costs are not irrelevant in the case of a mass-produced item used by almost every home nationwide.

Thus far, it has been discovered that the injection-molded plastic body has to partially reinforced by a laminar surface reinforcement, in order to achieve an overall reduction of wall thickness in the flat areas of the trash can or injection-molded plastic body.

In the case of a trash can with a capacity of 240 l, for example, the usual wall thickness of flat regions of injection-molded plastic body may be advantageously reduced from 4 mm to an average of 2.75 mm, if the trash can or the injection-molded plastic body is partially provided with a laminar surface reinforcement with a wall thickness of preferably 3 mm.

It is understood that such a laminar surface reinforcement may be of varied nature. This laminar surface reinforcement is in particular different from a linear material reinforcement that is in particular achieved by an edge or web that extends, for example, along a side wall, in the longitudinal or width direction of a side wall.

This laminar surface reinforcement is many times larger than its thickness, both in its longitudinal and width direction. In particular, its width is at least 10 or 20 times the thickness of the laminar surface reinforcement.

According to a preferred embodiment the laminar surface reinforcement comprises a material thickening. A partial material thickening may be particularly easy to achieve by injection molding.

The term “flat material thickening” in the sense of the invention, describes areas, in particular inside the side walls and/or corners that are characterized by a greater wall thickness than adjoining areas of the trash can lacking such a flat material thickening. This material thickening comprises a thickening of more than 10% or more than 15% and less than 30% or less than 20% of the surface areas of side walls produced or injection molded without this laminar surface reinforcement. In this way, a very good ratio between additional material used and higher stabilizing and reinforcement effects may be achieved. Absolute values of laminar surface reinforcement essentially depend on the size of the trash can or its capacity.

The inner structure of the plastic body, in particular at boundaries between the laminar surface reinforcement and the other non reinforced regions of the trash can, may in particular be reinforced, if the laminar surface reinforcements are unitarily connected to the adjoining material regions of injection-molded plastic body.

The injection-molded plastic body is partially reinforced by a laminar surface reinforcement extending over the entire length, or at least over more than half the front side wall. In this way, the trash can may be partially reinforced over its entire length.

If the laminar surface reinforcement includes the corners of the trash can adjacent the front side surface, the trash can may be provided with a particularly stable form. Since the trash can, for example in case of lifting and tilting movements, in particular during an emptying process, frequently buckles at front corners, it is advantageous if these corners are surface reinforced.

Moreover, the trash can may be better protected from hard blows that are transmitted to the trash can, in case of impacts on a floor. Normally, trash cans impact the floor, during handling, with the lower end of their front corners.

The dimensional stability may be further enhanced if the laminar surface reinforcement, as viewed in the circumferential direction of the trash can, on corners at the upper side of the trash can has a larger width than on the under side of the trash can.

The laminar surface reinforcement is provided on the trash can in such a way as to preferably at least completely include both front corners of the trash can.

The trash can may be particularly robust, if the laminar surface reinforcement extends into edge regions adjacent the corners of front side walls and/or of lateral side walls. In this case, the material reinforcement of these corners preferably extends over the curved area of corners, 5 mm or 10 mm deep into the more planar areas of side walls.

The trash can may further be very advantageously reinforced if the laminar surface reinforcement forms a three-dimensional surface structure inside the injection-molded plastic body of the trash can. Such a three-dimensional surface structure may be very simply created by the curved corners of the trash can.

It is also advantageous if the laminar surface reinforcement forms a U-shaped surface structure inside the injection-molded plastic body of the trash can. In this way, a less loaded wall region of the trash can may be surrounded by a flat reinforced area of the trash can, so that it is also supported and stabilized. Therefore, this surrounded and less loaded area may also be less thick. Therefore, less material may be used also in this region.

The U-shaped surface structure is preferably open toward the bottom wall. In this way, it is possible to reduce the material on the trash can underside, and the trash can is stiffer at its upper side.

If the laminar surface reinforcement comprises a flat upper belt on the upper side of the trash can that connects to each other the corners flanking the front side wall, the more loaded upper side of the trash can may be better protected in particular with respect to buckling.

In this case, it is particularly advantageous if the flat upper belt extends into the overhang edge. In this way, in particular the collar, which projects radially outward from the side walls, may be advantageously reinforced.

Insofar it is advantageous, if areas of a front overhang edge segment comprise the laminar surface reinforcement. In particular, also the front overhang edge segment is frequently subject to high loads, so that a material reinforcement provided in this position, in particular of the collar, which projects radially outward from the front side wall, is very advantageous. In this case, the trash can may be advantageously reinforced starting from the overhang edge, at least on the heavily loaded front side of the trash can. The front overhang edge segment preferably has a material thickness equal to or higher than 3 mm.

If the laminar surface reinforcement is supported by a grating structure, the effect of the laminar surface reinforcement, in particular on the overhang edge, may be also strengthened by only small material additions.

Furthermore, independently from the other characteristics of the invention, it is advantageous if the ribs spaced along the overhang edge are provided with different rib thicknesses. Also in this way a very specific reinforcement of the trash can may be obtained where it is most effective.

Additional material is therefore preferably introduced in regions of the trash can, where reinforcement effects are the most effective.

Hence, an advantageous embodiment is that the ribs provided on the front overhang edge segment have different rib wall thicknesses, preferably larger than other ribs of the overhang edge.

The ribs of the overhang edge are positioned in the circumferential direction and along the overhang edge as well as underneath the collar such that they are unitarily connected on one hand to the collar and on the other hand to the respective side wall of the trash can.

The ribs are aligned, regarding their longitudinal extension, with the longitudinal extension of side walls, and the thickness of the ribs is measured transverse to the longitudinal extension,

Advantageously, the ribs positioned on the front overhang edge segment are at least more than 10%, preferably more than 15% thicker than other ribs of the overhang edge.

Ribs positioned on the front overhang edge segment, with regard to a trash can with a capacity of 240 l, have a rib thickness of 4.0 mm for example, whereas other ribs of the overhang edge have a maximum thickness of 3.5 mm, 3.07 mm or less.

Insofar it is advantageous, if the ribs that are positioned over a front corner on the overhang edge have a reduced rib thickness with respect to ribs that are positioned on the front overhang edge segment, but a larger rib thickness than other ribs of the overhang edge.

These ribs positioned over a front corner on the overhang edge, referred to the trash can with a capacity of 240 l, are at least 3.5 mm thick. In this way it is in particular possible to avoid a critical bending of the collar and to improve the stability of the overhang edge.

If the ribs positioned above the back corners on the overhang edge have a smaller rib thickness than ribs positioned on the front overhang edge segment and above a front corner but a greater thickness than other ribs of overhang edge, then the ribs that are positioned above a back corner on the overhang edge and less loaded ribs may also be less massively constructed.

The ribs positioned above a back corner on the overhang edge have a rib thickness of 3.07 mm, for example, in case of the selected trash can with a capacity of 240 l.

The ribs provided on the lateral and back overhang edge segments may be correspondingly thinner than the ribs that are positioned above a back corner on the overhang edge.

It is understood, that the characteristics of previous solutions, i.e. solutions described in the claims, may be optionally combined with each other in order to obtain cumulative advantages.

In any case, through the provided reinforcements the trash can according to the invention may be partially reinforced in the regions where the trash can is heavily loaded during day-to-day use. In this way it is possible to provide in a cost effective way a durable but, as far as weight is concerned, still easy to handle trash can.

Further characteristics, effects and advantages of this invention are explained with reference to the attached drawing and the following description, in which an illustrative example of an embodiment of a trash can with a capacity of 240 l, according to the invention, is shown and described.

In the drawing, in particular:

FIG. 1 is a schematic and perspective view of a trash can with an injection-molded plastic body partially reinforced by a laminar surface reinforcement, in which the laminar surface reinforcement extends over the entire length of the front side wall, on both faces of this front side wall,

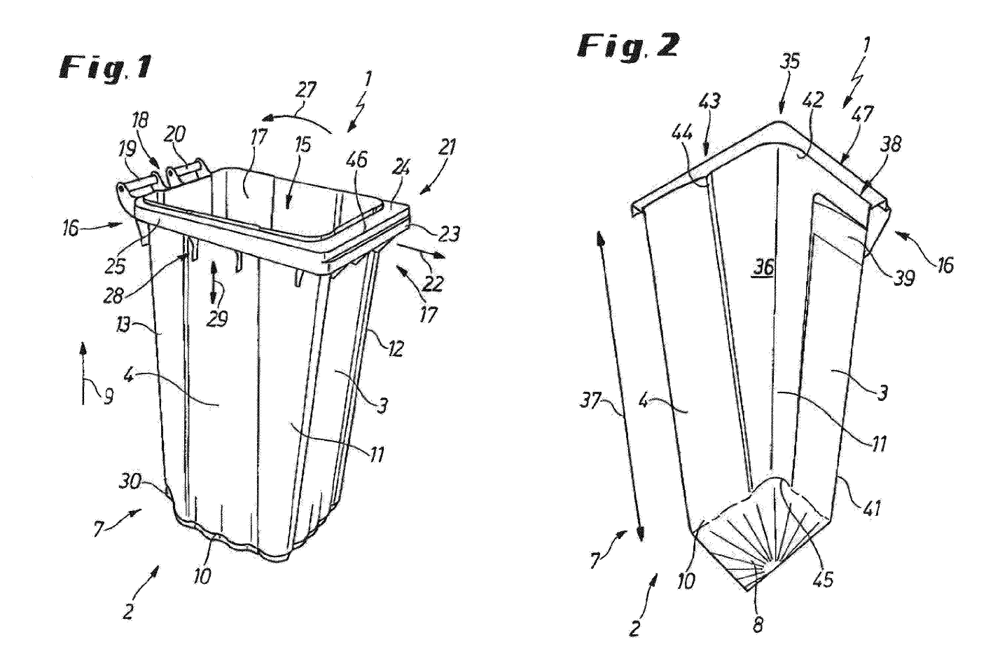

FIG. 2 is a schematic sectional and perspective view of a front corner of the trash can of FIG. 1,

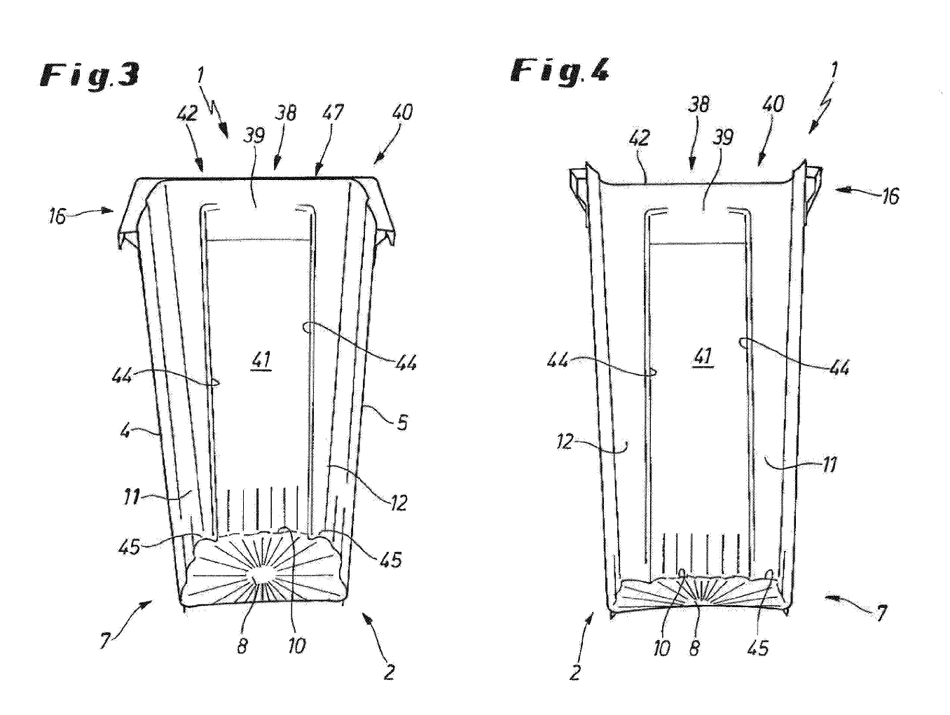

FIG. 3 is a schematic double sectional front view of the trash can of FIGS. 1 and 2;

FIG. 4 is a schematic sectional rear view of the trash can of FIGS. 1 to 3;

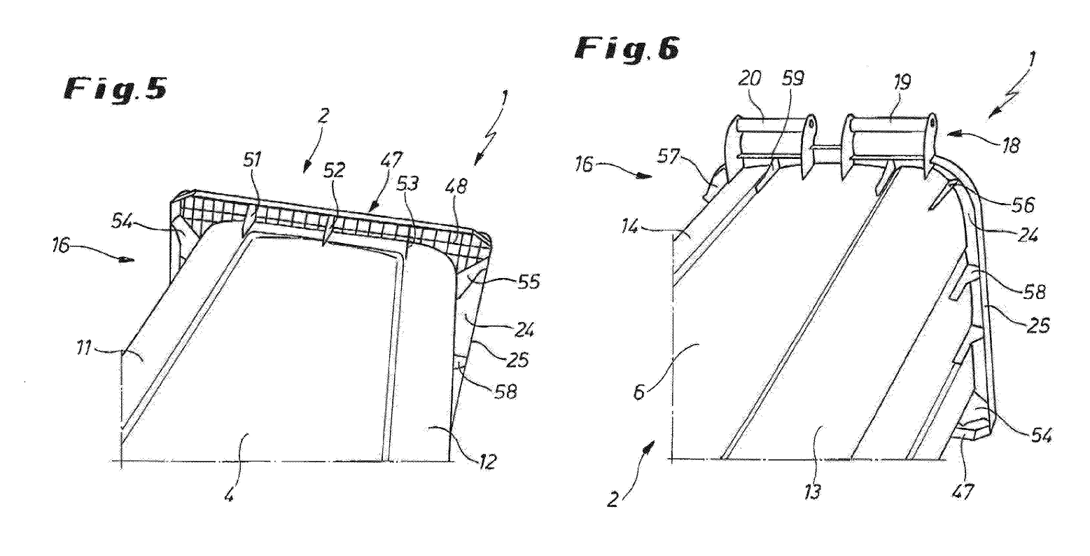

FIG. 5 shows another schematic partial sectional view, in particular of the front overhang edge segment of the trash can of FIGS. 1 to 4 as viewed from below;

FIG. 6 shows a further schematic partial sectional view, in particular of the back overhang edge segment of the trash can of FIGS. 1 to 5 as viewed from below; and

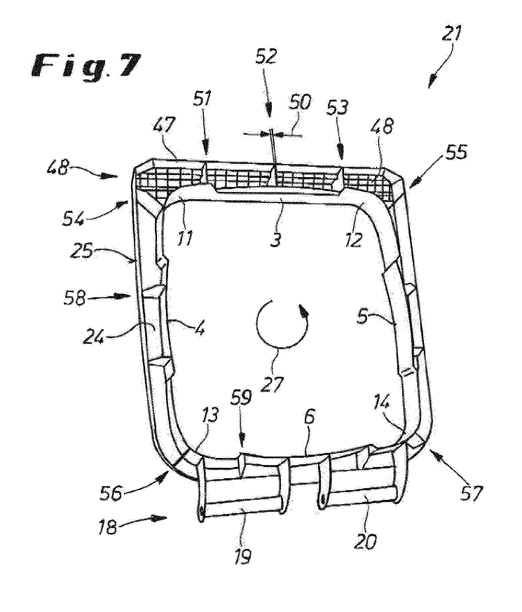

FIG. 7 is a schematic sectional view of the upper side of the trash can of FIGS. 1 to 6 as viewed from below.

The trash can 1 shown in FIG. 1 is provided with an injection-molded plastic body 2. This injection-molded plastic body 2 forms the side walls 3, 4, 5 and 6 of the trash can 1, i.e. a front side wall 3, a first lateral side wall 4, a second lateral side wall 5 (see in particular FIG. 3) and a back side wall 6 (see FIG. 6).

The trash can 1 is also provided on its underside lower part 7 with a bottom wall 8 also formed by the injection-molded plastic body 2 (see for example FIG. 2). The side walls 3, 4, 5 and 6 extend from the bottom wall 8 up in a direction 9, and the side walls 3, 4, 5, 6 are integrally connected with this bottom wall 8 at their respective lower ends 10 adjacent the bottom wall 8 (with exemplary numbering).

Both lateral side walls 4 and 5 are integrally connected in two front corners 11 and 12 of the trash can 1 to the opposite front side wall 3 at two back corners 13 and 14 of the trash can 1 to the opposite back side wall 6. The side walls 3, 4, 5 and 6 as well as the bottom wall 8 are positioned with respect to each other such that they define together a cavity 15 with a capacity of 240 l for holding trash. This cavity 15 may be accessed from the upper side 16 of the trash can 1 through an opening 17 and may be closed by an unillustrated lid. The lid may be rotatably attached by a support 18 embedded in two handles 19 and 20 of the trash can 1 on the same trash can 1.

The opening 17 is surrounded by an overhang edge 21 that also forms an upper end of the trash can 12 and on which the lid is placed when the trash can 1 is closed.

At the same time, the overhang edge 21 allows insertion from underneath of lifting devices for lifting the trash can 1, for example when emptying the trash can 1 into a dumpster.

The overhang edge 21 has a collar 23 that projects outward in a radial direction 22 (only illustratively shown) from side wall 3 to 6. This collar 23 has a horizontal leg 24 projecting essentially perpendicular from side walls 3 to 6 and a vertical leg 25 bent downward and perpendicular, essentially at a right angle from the leg 24.

In an space 26 formed by the legs 24 and 25 between the collar 23 and side walls 3 to 6, a plurality of ribs 28 are positioned in a circumferential direction 27 of the overhang edge 21 and spaced along the overhang edge 21 that support the overhang edge 21, i.e. its collar 23. The ribs 29 have a longitudinal extension 29 in the vertical direction 9 of the side walls 3 to 6.

On the back side wall 6 above the bottom wall 8 there is an axial support 30 that supports a wheel axle (not shown) may be supported, so that the trash can 1 may also roll.

As is easily seen in FIGS. 2 to 4, the trash can 1 is characterized, with respect to its injection-molded plastic body 2 in this example, by at least a laminar surface reinforcement 35 formed by a flat material thickening 36. This material reinforcement 35 is such that the wall thicknesses of the trash can, while maintaining the capacity of 240 l like conventional trash cans, are reduced as a whole. This is in general specifically valid for side walls 3 to 6 of the trash can 1.

At the laminar surface reinforcement 36, the wall thickness of the trash can 1 is at least 3 mm, whereas the wall thickness of other unreinforced flat surfaces of the trash can 1 is less than 3.0 mm, preferably 2.75 mm.

The laminar surface reinforcement 35 is also configured so that it extends over both all of both front corners 11 and 12 and also an upper region 38 of the front side wall 3.

The longitudinal as well as the width extension of the laminar surface reinforcement are many times greater than its thickness. The longitudinal extension is aligned with the length of side surfaces 3 to 6 in the vertical direction 9, whereas the width extension is transverse to the direction 9. The thickness of the laminar surface reinforcement 35 corresponds to the wall thickness of both the front corners 11 and 12.

The upper region 38 extends as a flat upper belt 39 between both front corners 11 and 12 and connects these to each other such that the laminar surface reinforcement 35 forms a U-shaped surface structure 40 open toward the bottom wall 8, inside the injection-molded plastic body 2 on the front side wall 3 of the trash can 1.

At the same time, the front side wall 3 is formed by only a flat essentially rectangular window area 41 of reduced wall thickness. In this way, this less loaded flat window area 41 may be lighter.

Just one of the front corners 11 or 12 forms, due to its curved structure, the laminar surface reinforcement 35 as a three-dimensional surface structure 42, so that the injection-molded plastic body 2 becomes particularly torsion-proof.

The resistance or stability of the trash can is further increased since the laminar surface reinforcement 35 is integrated into the injection-molded plastic body 2 of the trash can 1, such that it is integrally connected to adjacent material regions 43 of the injection-molded plastic body 2, being joined in this way with edge portions 44 (only illustratively numbered) of front and lateral side walls 3 or 4 and 5. As an example, in this case, merge regions 45 between corners 11 or 12 and bottom wall 8 are also included.

This laminar surface reinforcement 35 extends and widens, starting from the underside 16, up to the upper side 16 of the trash can 1, so that the laminar surface reinforcement 35 is wider on the upper side 16 so that this upper side 16 is particularly resistant and stable.

Moreover, the flat upper belt 39 extends into regions 46 of the overhang edge 21 or into the front overhang edge segment 47 so that the overhang edge 21 is also strengthened by the laminar surface reinforcement 35 in one of the most heavily loaded positions. The front overhang edge segment 47 has in this case a material thickness of 3 mm.

The laminar surface reinforcement 35 is also and advantageously supported by an injection-molded grating structure 48, as in particular in the case of the front overhang edge segment 47 (see FIG. 5).

In particular, according to FIGS. 5 to 7, the structure of the trash can 1 is further partially reinforced by the plurality of ribs 28 with respect to the upper side 16, and the trash can 1 is characterized in that the ribs 28 spaced along the overhang edge 21 have different rib thicknesses 50 (only illustratively numbered with reference to FIG. 5).

The three front ribs 51, 52, 53 on the front overhang edge segment 47 have a rib thickness of 4.00 mm and therefore the greatest rib thickness of ribs 28 (see in particular FIG. 7).

The other directly adjacent ribs 54 and 55 above the front corners 11 and 12 on the overhang edge 21, on the contrary, already have a smaller rib thickness of 3.5 mm.

The other ribs 56 and 57 provided above the back corners 13 and 14 on the overhang edge 21 also have a smaller rib thickness with respect to the ribs 51, 52, and 53, provided on the front overhang edge segment 47. Their rib thickness is also less than the ribs 54 and 55 positioned above the front corners 11 and 12. The ribs 54 and 57 however have a greater rib thickness than other ribs 58 positioned between ribs 54 and 56 and 55 and 57, (only illustratively numbered) and the ribs 59 positioned between the ribs 56 and 57 (also only illustratively numbered).

These optimized ribs 28 also can improve the form stability and the weight of the trash can 1.

It is understood, that this embodiment is only a first embodiment of the inventive trash can. Insofar, the invention is not limited to this embodiment.

All characteristics disclosed in the application are claimed as essential to the invention, provided that they, individually or in combination, are new with respect to the prior art.
1 trash can
2 plastic body
3 front side wall
4 first lateral side wall
5 second lateral side wall
6 back side wall
7 underside
8 bottom wall
9 direction
10 lower ends
11 first front corner
12 second front corner
13 first back corner
14 second back corner
15 cavity
16 upper side
17 opening
18 support
19 first handle
20 second handle
21 overhang edge
22 radial direction
23 collar
24 horizontal leg
25 vertical leg
26 interstitial space
27 circumferential direction
28 plurality of ribs
29 longitudinal extension
30 axial support
35 laminar surface reinforcement
36 flat material thickening
37 total length
38 upper region
39 upper belt
40 u-shaped flat structure
41 window area
42 three-dimensional flat structure
43 adjoining material areas
44 edge regions
45 merge regions
46 regions
47 front overhang edge portion
48 grating structure
50 rib thickness
51 to 59 ribs

1. A trash can having an injection-molded plastic body formed by
side walls,
a bottom wall positioned relative to the side walls so as to together define a cavity having an opening opposite the bottom wall, each side wall integrally merging into the adjacent side walls at common corners,
an overhang edge that runs around the opening and has a collar projecting radially outward from the side walls on an upper side of the trash can and also supported on the side walls by ribs spaced along the overhang edge, and
a laminar surface reinforcement partially reinforcing the injection-molded plastic body such that the wall thicknesses of the trash can are reduced as a whole while maintaining the same capacity, the laminar surface reinforcement extending over the entire length or at least over more than half of the front side wall. having a thickness more than 10% thicker than unreinforced regions of the side walls, and forming a three-dimensional surface structure inside the injection-molded plastic body of the trash can.

2. The trash can according to claim 1, wherein the laminar surface reinforcement comprises a flat material thickening.

3. The trash can according to claim 1, wherein the laminar surface reinforcement extends into the corners of the trash can that are adjacent the front side surface.

4. The trash can according to claim 1, wherein the laminar surface reinforcement extends into edge regions of front side wall and/or of lateral side walls that are adjacent corners.

5. The trash can according to claim 1, wherein the laminar surface reinforcement has a larger width in the front corners in the circumferential direction of the trash can on an upper side of the trash can than on the underside of the trash can.

6. (canceled)

7. The trash can according to claim 1, wherein the laminar surface reinforcement forms a U-shaped surface structure inside the injection-molded plastic body of the trash can.

8. The trash can according to claim 1, wherein the laminar surface reinforcement comprises a flat upper belt on the upper side of the trash can that connects the corners adjacent the front side wall to each other.

9. The trash can according to claim 8, wherein the flat upper belt extends into regions of the overhang edge.

10. The trash can according to claim 1, wherein the laminar surface reinforcement extends over a front overhang edge segment.

11. The trash can according to claim 1, wherein the laminar surface reinforcement is supported by a grating structure.

12. The trash can according to claim 1, wherein the ribs spaced along the overhang edge have different rib thicknesses.

13. The trash can according to claim 1, wherein the ribs on a front overhang edge segment have a greater rib thickness than other ribs of the overhang edge.

14. The trash can according to claim 1, wherein the ribs positioned on a front overhang edge segment have a thickness at least more than 10% greater than other ribs of the overhang edge.

15. The trash can according to claim 1, wherein the ribs provided above a front corner on the overhang edge have a rib thickness smaller than ribs positioned on the front overhang edge segment, but greater than other ribs of the overhang edge.

16. The trash can according to claim 1, wherein the ribs positioned above a back corner on the overhang edge have a rib thickness smaller than the ribs provided on the front overhang edge segment and positioned above a front corner, but greater than other ribs of the overhang edge.
